(19) United States
(12) Patent Application Publication
(10) Pub. No.: US 2007/0195958 A1
(43) Pub. Date: Aug. 23, 2007

(54) EXTENSIBLE CLOSED-LOOP SECURITY SYSTEM

(76) Inventor: Andrew J. Czuchry, Auburn, GA (US)

Correspondence Address: W. EDWARD RAMAGE, COMMERCE CENTER SUITE 1000, 211 COMMERCE ST, NASHVILLE, TN, 37201, US

(21) Appl. No.: 11/677,884

(22) Filed: Feb. 22, 2007

Related U.S. Application Data
(60) Provisional application No. 60/775,705, filed on Feb. 22, 2006.
(60) Provisional application No. 60/775,581, filed on Feb. 22, 2006.

(51) Int. Cl. H04L 9/00

(52) U.S. Cl. 380/277

(57) ABSTRACT

An extensible, closed-loop secure system with integrated feedback. One particular embodiment comprises a closed-loop security system with secured closed-loop endpoints, secure ring of connectivity, and secure program logic. The closed loop security system transports encapsulated security packets among secure closed-loop endpoints, through an interconnectivity pipeline, with secure control flow managed by a distribution ring and a secure control core. The closed loop system provides a number of functional features, including but not limited to: a secure backbone, with tracking and feedback, independent of limitations of available bandwidth; a communication abstraction layer (providing functionality to send, track, receive, review, and provide feedback); a transmission abstraction layer isolating physical transmission mechanisms (isolating the transmission mechanisms from the physical format of the copper wire, fiber, microwave, satellite, power lines, or cellular); a security abstraction layer (providing authentication, encryption, digital rights management [DRM], digital signatures); a feedback abstraction layer (providing reporting); a system integration abstraction layer (providing links to demographic data, subscription services, backend financial systems); and initial productivity modules (providing modules for audio/video send messages, receive messages, review messages, and reporting).

This application claims priority to U.S. Provisional Patent Application No. 60/775,705, filed Feb. 22, 2006, by Andrew Czuchry, and U.S. Provisional Application No. 60/775,581, filed Feb. 22, 2006, by Andrew Czuchry, and is entitled in whole or in part to those filing dates for priority. The disclosure, specification and drawings of Provisional Patent Application Nos. 60/775,705 and 60/775,581, and U.S. patent application Ser. No. 10/986,972 (“Apparatus and Method Providing Distributed Access Point Authentication and Access Control with Validation Feedback,” Czuchry, et al., filed Nov. 12, 2004), Ser. No. 10/914,693 (“Content Distribution and Incremental Feedback Control Apparatus and Method,” Czuchry, et al., filed Aug. 9, 2004), and Ser. No. 11/269,444 (“Content Distribution and Incremental Feedback Control Apparatus and Method,” Czuchry, et al., filed Nov. 8, 2005), are incorporated herein in their entireties by reference.

### TECHNICAL FIELD

The present invention relates to information management and telecommunications systems. More particularly, the present invention relates to an extensible system for securely defining, securely maintaining, and securely handling the storage, access, and transfer for digital content embodiments within both localized and non-localized digital communication channels.

### BACKGROUND OF THE INVENTION

Increasingly common forms of digital technology abound (e.g., the internet, cell phones, text messaging, iPods™, Xboxes™, DVRs). As advancing technology continues to permeate the fabric of an increasingly global society, an expanding spectrum of content is being exchanged electronically. Digital technologies and applications abound, each attempting to process the mounting volume of electronic data exchange (e.g., VOIP [voice over ip], IPTV [television over ip], VOD [video on demand], DVD, HDTV, electronic search, digital telephony, digital music, digital theaters, digital books, scanned copies of books, electronic financial information, electronic medical records, and personal identification information). Each limited in scope primarily by the perspective in which the solution context is viewed, the individual applications within these technologies fundamentally target a relatively specific type of digital content to transfer; these technologies thus foster “application specific solutions”. An alternative view is to address the entire spectrum as a unified picture of handling and transferring information in a “global, digital universe”. Furthermore, given the diversity of the digital universe where packaging and transferring digital content is becoming increasingly essential, expanded consideration is vital. Since much of this content is sensitive or copyrighted information, the need for architecting a secure system to exchange this content is of paramount importance.

Two basic approaches to creating a secure backbone for foundational core transmissions present themselves as options. The simplest and most direct approach is to create an “open system,” where digital messages can be transferred efficiently and security can be built around the open system to protect its integrity. An example of such an approach is to leverage the connectivity of the internet by crafting a communication web where firewalls are used to protect specific entry points between the internet and the network(s) of local computers or internal access points. The other basic option is to build a “closed system” where security is foundationally integrated throughout the system and access from outside the system is totally prohibited. An example of a “closed system” is a secured local area network with no connectivity to the internet and no connectivity to any other network.

An “open system” can have universal applicability, given that no breaches of security occur at any point along the communication path. A “closed system” can be highly secured but is typically restrictive in nature because the scope of the “closed” system is limited by definition.

The security exposure of an “open system” and the limited scope of a “closed system” are traditionally accepted liability alternatives when choosing a digital content communication implementation. Often ignored at the outset, but vital to also consider for the implementation process, are the behavior factors of people using these systems. Add these human behavior factors into the solution design and the complexity of developing and managing an effective solution increases exponentially. The need for secure solutions that provide the universality of an “open system” and the security of a “closed system” while simultaneously addressing the human behavior factors, therefore, present a tremendously ominous gap.

Accordingly, there is a need in the art for an extensible closed-loop system for maintaining the security of digital content handling within digital communication channels.

### SUMMARY OF THE INVENTION

This invention is directed to an information-based system for secure exchange of digital content. In an exemplary embodiment, the system integrates four distinct functional dynamics:

1. the universality of an “open system”,

2. the security of a “closed system”,

3. the encapsulation of digital content elements, and

4. the reality of human behavior factors.

The integration of these four elements defines a systematic framework for diverse application. This framework provides for handling digital communication among people in an encapsulated and fundamentally secure manner. The foundation of this framework is built by merging the content encapsulation and the security mechanisms into a unified information transfer system.

In one exemplary embodiment, the system uses modularized plug-compatible modules to form a closed-loop system with integrated feedback, in order to harness the power of the internet for secure communication. The closed-loop system provides several functional features:
a secure backbone, with tracking and feedback, independent of the limitations of available bandwidth
a communication abstraction layer (functionality to send, track, receive, review, and provide feedback)
a transmission abstraction layer isolating physical transmission mechanisms (e.g., copper wire, fiber, microwave, satellite, power lines)
a security abstraction layer (e.g., authentication, encryption, digital rights management [DRM], digital signatures)
a feedback abstraction layer (e.g., reporting)
a system integration abstraction layer (e.g., link to demographic data, subscription services, backend financial systems)
productivity modules (e.g., for audio/video send message, receive message, review message, and reporting)

The extensible system can be applied to secure and protect any type of information including but not limited to personal identity, confidential documents, financial data, voice messages, proprietary and/or copyrighted content. Such a system can be implemented using software technology, hardware technology, and/or a combination of hardware and software. Applications include but are not limited to secure data networks, secure voice networks, secure data storage, secure data processing, secure data transfer, and secure data usage.

Still other advantages of various embodiments will become apparent to those skilled in the art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is a schematic illustration of an extensible secure control system backbone in accordance with one exemplary embodiment of the present invention.

FIG. 2 is a schematic illustration of encapsulated security packets transferred and stored within the control backbone illustrated in FIG. 1.

FIG. 3 is a schematic illustration of the functional abstraction layers embodied within the control backbone illustrated in FIG. 1.

### DETAILED DESCRIPTION OF EXEMPLARY EMBODIMENTS

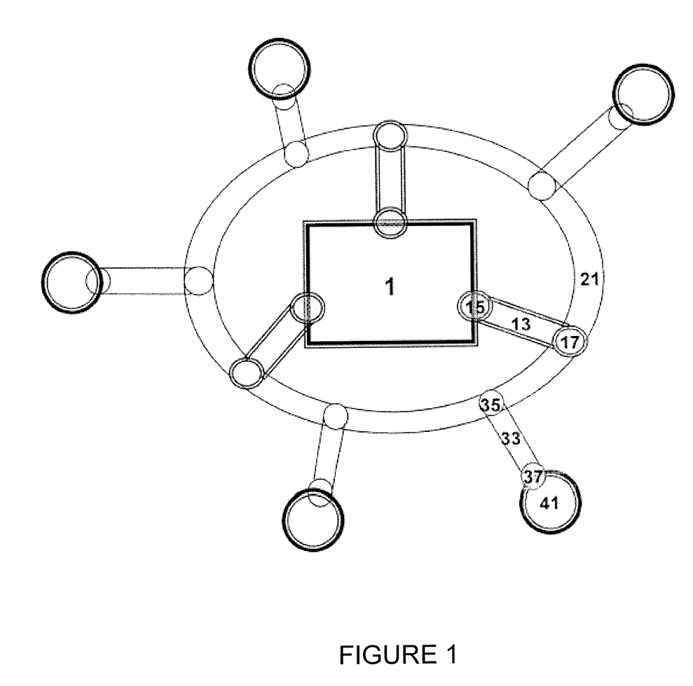

FIG. 1 shows a exemplary embodiment of a closed-loop secure system with integrated feedback encompassing a secure ring of connectivity and control flow distribution 21, with a secured core of program logic 1, and secured closed loop endpoints 41. Each of these elements, 1, 21, 41, can independently function as a stand-alone element, with defined rules of interaction programmatically integrating the elements as controlled through the program logic of the secured core 1.

Connectivity between the control flow distribution ring 21 and the secured core of program logic 1 is enabled through the connectivity control which produces a connectivity flow control tunnel 13. The security of connectivity control is managed by the programmable flow control valves 15, 17 that secure each end of the connectivity flow control tunnel 13 with secured authentication. Each control point intersection within the loop behaves like a flow control value that is opened only with the presentation of the proper credentials. Unique authentication identifiers ensure closed-loop security is maintained at the level of loop access/entry and within the loop itself.

Connectivity of the individual end points 41 to the control flow distribution ring 21 is managed through the secured extensibility tubes 33. The secured extensibility tubes 33 are secured by the programmable flow control values 35, 37 that secure each end of the extensibility tube 33 with secured authentication. Authentication can be performed at every interface interaction to ensure security is not breeched.

The computational processing result is that the program logic 1, the connectivity control 13, the ring of connectivity 21, the extensibility tubes 33, and the secured end points 41 form the secure control backbone. Internal flow control is programmatically provided by flow control valves with secured authentication 15, 17, 35, 37. These programmable flow control values are controlled through the program logic encoded in the control core 1. The program logic encoded within the control core 1 provides unique identity mapping control for all access into, within, and across the entire closed loop system.

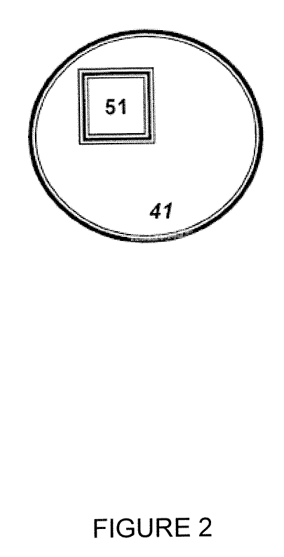

FIG. 2 is a schematic illustration of an encapsulated security packet of content 51, as stored in secured end-point 41, in accordance with an exemplary embodiment of the present invention. This secured packet of content 51 may embody an encryption header, authentication requirements, routing information, and content encryption. The encapsulated security packet of content 51 can be transmitted through the control backbone 1, 13, 21, 33, 41 with flow control provided through programmable flow control valves 15, 17, 35, 37. Digital content is packetized into the encapsulated packets 51, and the storage, transmission, and reconstitution of the digital content is controlled by interlacing encapsulated packets 51 based upon programmable control logic encoded in the control core 1. Presentation of improper credential destroys the interlacing process and thus ensures protection of the original digital content.

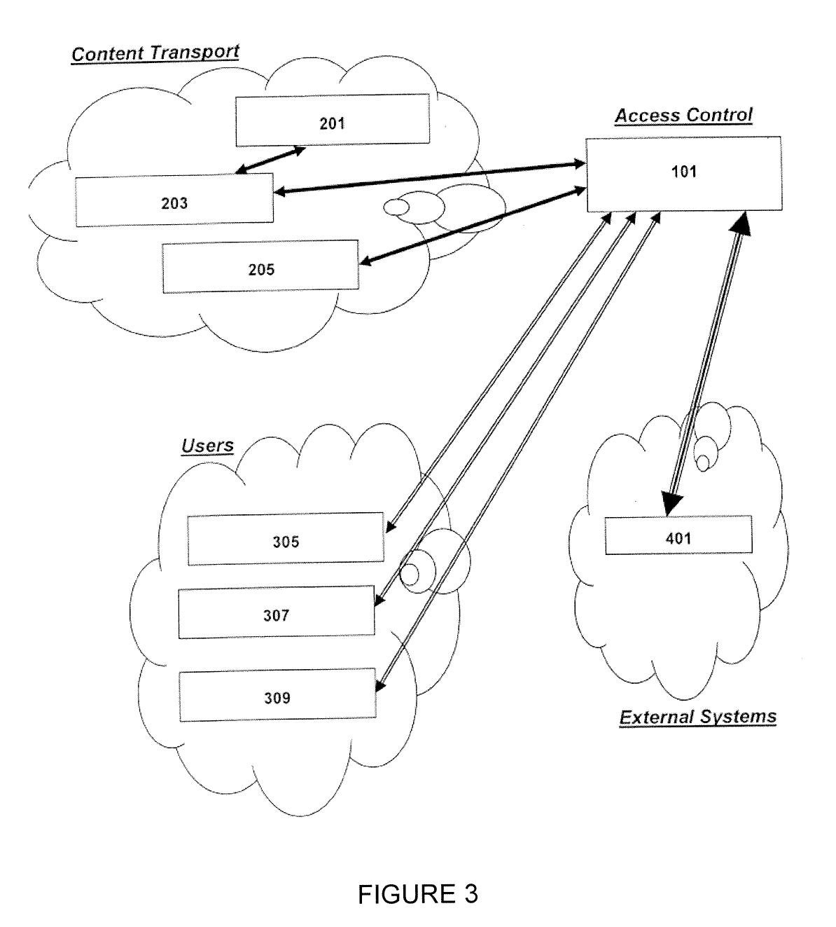

FIG. 3 is a schematic illustration of functional abstraction layers embodied within the control backbone of FIG. 1, in accordance with one exemplary embodiment of the present invention. A secure access control abstraction layer is maintained through the access security module 101. This module provides an abstraction layer for functionality including but not limited to authentication, encryption, digital rights management (DRM), digital signatures, access control, and logical connectivity.

The secure transport functionality abstraction layer is maintained through three control modules: transmission 201, communication backbone 203, and the content repository 205. The transmission module 201 provides an abstraction layer for functionality including but not limited to physical content format, bandwidth availability, and physical connectivity. The communication backbone module 203 provides an abstraction layer for functionality including but not limited to send, track, receive, review, and feedback capture. The content repository module 205 provides an abstraction layer for functionality including but not limited to the encapsulated content.

The productivity module abstraction layer is maintained through one or more productivity modules 309. The productivity module 309 provides an abstraction layer for functionality including but not limited to audio/video content, library archives, graphical content, and formatted text content. A secure integration to external systems abstraction layer is provided through the system integration module 401. The system integration module 401 provides an abstraction layer for functionality including but not limited to secured external links (e.g., links to subscription services).

The system can be realized as a hardware implementation, or a software implementation, or a mixed mode hardware and software implementation. While the actual digital content transferred through various application specific technologies may represent a variety of different messages (e.g., voice, music, video, graphics, pictures, or text messages), the synthesizable core of each remains equivalent across the spectrum: packetized electronic data exchange 51. This core of packetized exchange is based on the transfer of the elemental digital packets 51 that comprise the digital content. The present invention was created to process this core exchange, and thereby facilitate virtually any type of content transfer, rather than merely serving as a specifically tailored solution for the actual category of content being processed.

Given the diversity of the digital universe where packaging and transferring digital packets of contents is becoming increasingly essential, building a foundational core technology has far-reaching application potential. This potential is greatly enhanced by basing the foundation on exchanging digital packets that are universal in nature and can encapsulate any specific type of content desired.

To achieve this objective, one embodiment of the present invention may be based on exchanging encapsulated digital packets of content 51, independent of the specific types of content. This embodiment has multi-dimensional universal application for any type of messaging (including, but not limited to, video, voice, data, and text). An embodiment also may be based on a programmatically extensible “closed system” 1, 13, 21, 33, and 41. This embodiment meets the needs of both foundational security and potentially universal connectivity. Based on an extensive understanding of human behavior, the system may flexibly integrate into business and personal environments and not impose restrictive models for user interaction. At its very core, embodiments of the present invention may facilitate the secure transport of digital information in virtually any human behavior context.

The net result of integrating each of the pieces into a unified system produces a virtual kaleidoscope of functionality while maintaining its multi-dimensional secure core 101. The extensible “closed system” foundation keeps the entire system secure at all times. The encapsulation of digital content packets ensures integrated extensibility and security for virtually any content format.

Given the ever-present and increasingly vital need for non-leaky security in an expanding universe of digital communication, embodiments of the present invention may be built with integrated security woven into its most basic core 1, 13, 21, 33, 41. Within this core, two fundamental dimensions of secure communication are inextricably intertwined: data transmission and transmission security 201, 203, and 205. By weaving these dimensions together in an intricate pattern at the very core, each is inseparable from the other. When leveraging the transmission capabilities of the technology 201, and even when adding new aspects of transmission functionality, security remains a fundamental part of the technology.

The security woven into the communication core 101 ensures that any system application using some embodiments of the present invention defaults to “lock out” mode. In this mode, any application utility or application users must specifically request secure access and no access is granted without authenticating the request. This woven security approach is in direct contrast to systems where security specifically specifies “access that is prohibited.” The contrast is most apparent when reviewing the default behavior. The default behavior of the present invention is that people cannot access any information unless specifically granted rights to access that information. The default behavior of the contrasting “specifically prohibited” approach produces a by-product of unintended results such that people can effectively access information unless explicitly prohibited from such access. Even if “specifically prohibited” is extended to the outermost levels of security, the typical result is still a sequence of “patching security holes” as issues are exposed through users accessing information inappropriately. By weaving security into the very core of all functionality in the present invention, based on “lock out” modes that are opened only when authenticated access privilege is verified, the risk of compromised security is significantly mitigated.

Thus, in one embodiment, content rights can remain with, and be controlled by, the sender through encapsulation mechanisms as described herein. Similarly, content rights can remain with, and be controlled by, the sender through a controlled distribution and/or feedback loop. Content and content modules can be retracted via encapsulation mechanisms and/or control loop mechanisms, or by encapsulation mechanisms with or without a controlled distribution and/or feedback loop.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for the particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

I claim:

1. A closed-loop security system, comprising:
a secured program logic core,
a secured control flow distribution ring in electronic communication with the secured program logic core, and
one or more secured, closed-loop endpoints in electronic communication with the secured control flow distribution ring.

2. The system of claim 1, wherein the secured control flow distribution ring electronically communicates with the secured program logic core through one or more connectivity flow control tunnels.

3. The system of claim 2, wherein said connectivity flow control tunnels have one or more programmable flow control valves that secure each end of the tunnel where it connects with the secured control flow distribution ring or secured program logic core.

4. The system of claim 3, wherein said programmable flow control valves open only with the presentation of authentication identifiers.

5. The system of claim 1, wherein the secured control flow distribution ring electronically communicates with a secured, closed-loop endpoint through one or more secured extensibility tubes.

6. The system of claim 5, wherein said secured extensibility tubes have one or more programmable flow control valves that secure each end of the tube where it connects with the secured control flow distribution ring or secured, closed-loop endpoint.

7. The system of claim 6, wherein said programmable flow control valves open only with the presentation of authentication identifiers.

8. The system of claim 3, wherein said programmable flow control valves are controlled by the secured program logic core.

9. The system of claim 6, wherein said programmable flow control valves are controlled by the secured program logic core.

10. The system of claim 1, further comprising one or more encapsulated secure content packets contained or stored in one or more secured, closed-loop end points.

11. The system of claim 10, wherein said encapsulated secure content packet comprises an encryption header, authentication requirements, routing information, and content encryption.

12. The system of claim 10, wherein said encapsulated secure content packet can be transmitted to the secured control flow distribution ring.
